(19) United States
(12) Patent Application Publication
(10) Pub. No.: US 2002/0067872 A1
(43) Pub. Date: Jun. 6, 2002

(54) Hydrodynamic compliant foil thrust bearing

(75) Inventor: Dennis Weissert, Sunland, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Capstone Turbine Corporation, Chatsworth, CA (US)

(21) Appl. No.: 09/997,305

(22) Filed: Nov. 30, 2001

Related U.S. Application Data
(60) Provisional application No. 60/250,633, filed on Dec. 1, 2000.

(51) Int. Cl. F16C 32/06

(52) U.S. Cl. 384/106

(57) ABSTRACT

One embodiment includes a plurality of equally spaced top foils and corrugated springs with one or more shims underneath the trailing edge of each corrugated spring. The corrugated spring forms an underspring for the top foil. Another embodiment incorporates one or more shims at the outer radius region of the corrugated spring in addition to the shim at the trailing edge of the corrugated spring. The shim under the trailing edge of the corrugated spring results in increased load capacity and stability and a decrease in lift-off speed of the rotating thrust disk. The shims located at the outer radii of the corrugated springs result in increased bearing stiffness at the outer region of the compliant foil thrust bearing where the highest pressure occurs.

### REFERENCE TO RELATED APPLICATION

This application claims the benefit of priority under 35 USC 119(e) of U.S. provisional application No. 60/250,633, filed on Dec. 1, 2000, which is incorporated herein by reference.

### TECHNICAL FIELD

This invention relates to the general field of compliant foil fluid film thrust bearings and more particularly to an improved compliant foil fluid film thrust bearings having top foils supported by corrugated springs and associated shims.

### BACKGROUND OF THE INVENTION

Compliant foil fluid film thrust bearings are described, for example, in U.S. Pat. No. 5,918,985, which is assigned to the assignee of present invention and which is incorporated herein be reference in its entirety.

FIG. 3 illustrates an attempt in the prior art to reduce the thrust disk lift-off/touchdown speeds and thereby reduce the wear on the thrust disk during the start and stop procedures. Between rotating thrust disk 302 and stationary thrust plate 304 are top foil 306 and corrugated spring 308. Top foil 306 and corrugated spring 308 are attached to thrust plate 304 at their leading edges by welding, brazing, or the like. The arrow 303 shows the direction of rotation of thrust disc 302. Shim 312 is placed between top foil 306 and corrugated spring 308 at the trailing edge 310 of top foil 306. Shim 312 is secured to corrugated spring 308 by welding, brazing, or the like. This construction has the disadvantage that top foil 306 is not capable of closely conforming to corrugated spring 308 in the region of shim 312 under load conditions. That disadvantage results in higher thrust disk lift-offtouch-down speeds than can be achieved with the present invention.

### I. SUMMARY OF THE INVENTION

In a first aspect, the present invention provides a compliant foil fluid film thrust bearing including:

a thrust disk rotatably supported by a non-rotating thrust bearing surface, the thrust disk having a direction of rotation; and

a compliant bearing operably disposed between the thrust disk and the non-rotating thrust bearing surface, the compliant bearing including:

a first corrugated spring, said first corrugated spring having a trailing edge with respect to the direction of rotation of the thrust disk;

a first shim between the first corrugated spring and the non-rotating thrust bearing surface, said first shim having a trailing edge substantially aligned with said first corrugated spring trailing edge; and

a top foil between the first corrugated spring and the thrust disk, the top foil having a trailing edge substantially aligned with the first corrugated spring trailing edge and the first shim trailing edge.

In another aspect, the present invention provides a method of making a compliant foil fluid film thrust bearing comprising the following steps:

providing a thrust disk rotatably supported by a non-rotating thrust bearing surface, the thrust disk having a direction of rotation; and

providing a compliant bearing operably disposed between the thrust disk and the non-rotating thrust bearing surface, the compliant bearing including:

a first corrugated spring, the first corrugated spring having a trailing edge with respect to the direction of rotation of the thrust disk;

a first shim between the first corrugated spring and the non-rotating thrust bearing surface, the first shim having a trailing edge substantially aligned with said first corrugated spring trailing edge; and

a top foil between the first corrugated spring and the thrust disk, the top foil having a trailing edge substantially aligned with the first corrugated spring trailing edge and the first shim trailing edge.

In another aspect, the present invention provides a compliant foil fluid film thrust bearing including:

first means rotatably supported by non-rotating second means, the first means having a direction of rotation; and

third means operably disposed between the first means and the non-rotating second means, the third means including:

first spring means, the first spring means having a trailing edge with respect to the direction of rotation of the first means;

first shim means between the first spring means and the non-rotating second means, the first shim means having a trailing edge substantially aligned with the first spring means trailing edge; and

top foil means between the first spring means and the first means, the top foil means having a trailing edge substantially aligned with the first spring means trailing edge and the first shim means trailing edge.

### BRIEF DESCRIPTION OF THE DRAWINGS

Having described the invention in general terms, attention is now directed to the accompanying drawings in which:

FIG. 1A is perspective view, partially in section, of an integrated turbogenerator system.

FIG. 1B is a magnified perspective view, partially in section, of the motor/generator portion of the integrated turbogenerator of FIG. 1A.

FIG. 1C is an end view, from the motor/generator end, of the integrated turbogenerator of FIG. 1A.

FIG. 1D is a magnified perspective view, partially in section, of the combustor-turbine exhaust portion of the integrated turbogenerator of FIG. 1A.

FIG. 1E is a magnified perspective view, partially in section, of the compressor-turbine portion of the integrated turbogenerator of FIG. 1A.

FIG. 2 is a block diagram schematic of a turbogenerator system including a power controller having decoupled rotor speed, operating temperature, and DC bus voltage control loops.

FIG. 3 is a sectional view of a prior art compliant foil fluid film thrust bearing.

FIG. 4 is a sectional view of a first embodiment of the present invention.

FIG. 5 is a sectional view of the present invention similar to FIG. 4 but including an optional second corrugated spring.

FIG. 6 is a sectional view of a second embodiment of the invention and including the optional second corrugated spring shown in FIG. 5.

FIG. 7 is a sectional view looking down on the thrust plate and showing the locations of the trailing edge shim and the outer radius shim of one of the wedges of the two illustrated fluid-dynamic wedge channels.

### DETAILED DESCRIPTION OF THE PREFERRED EMBODIMENT(S)

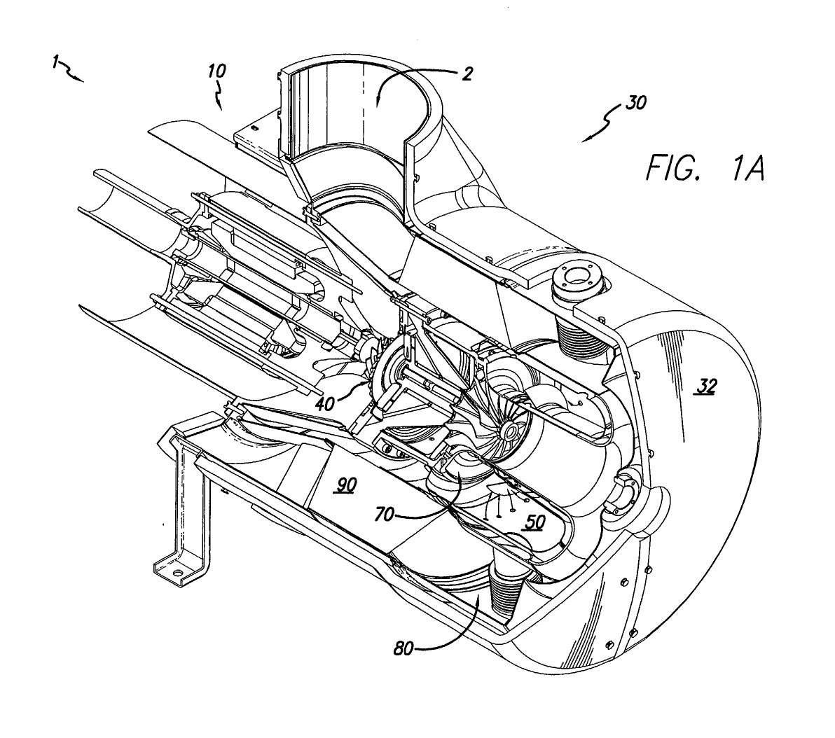

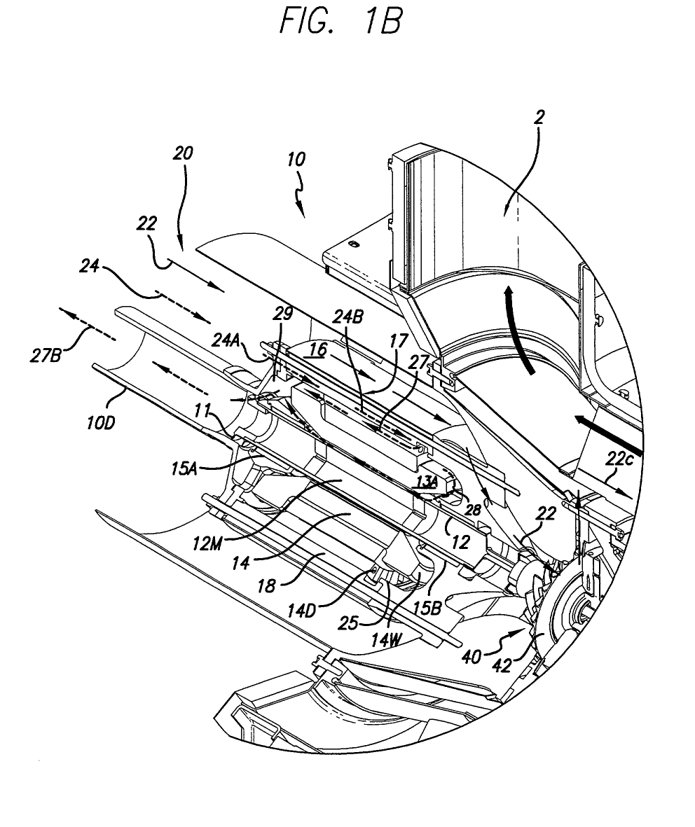

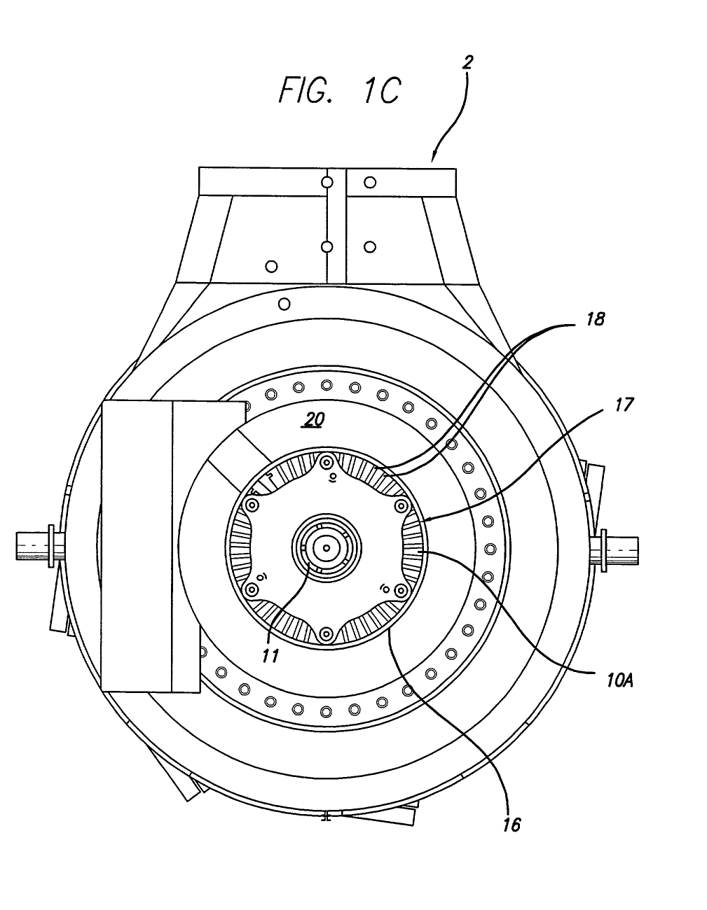

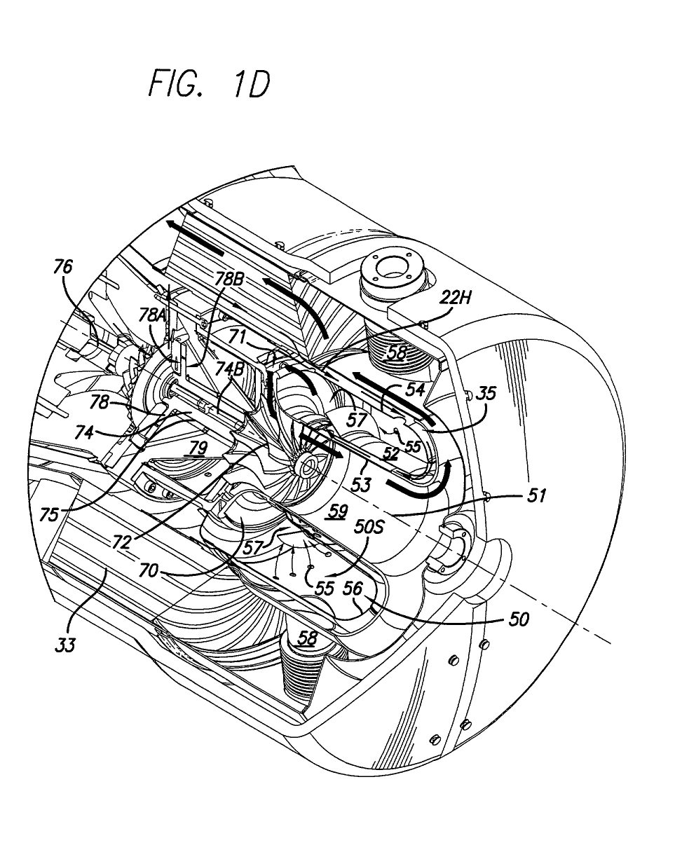

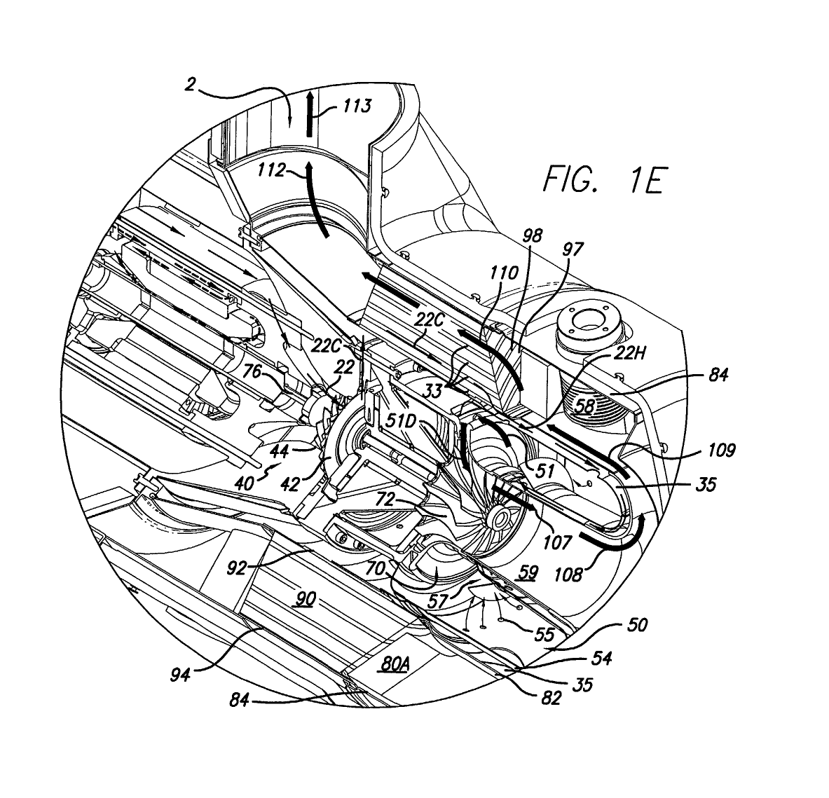

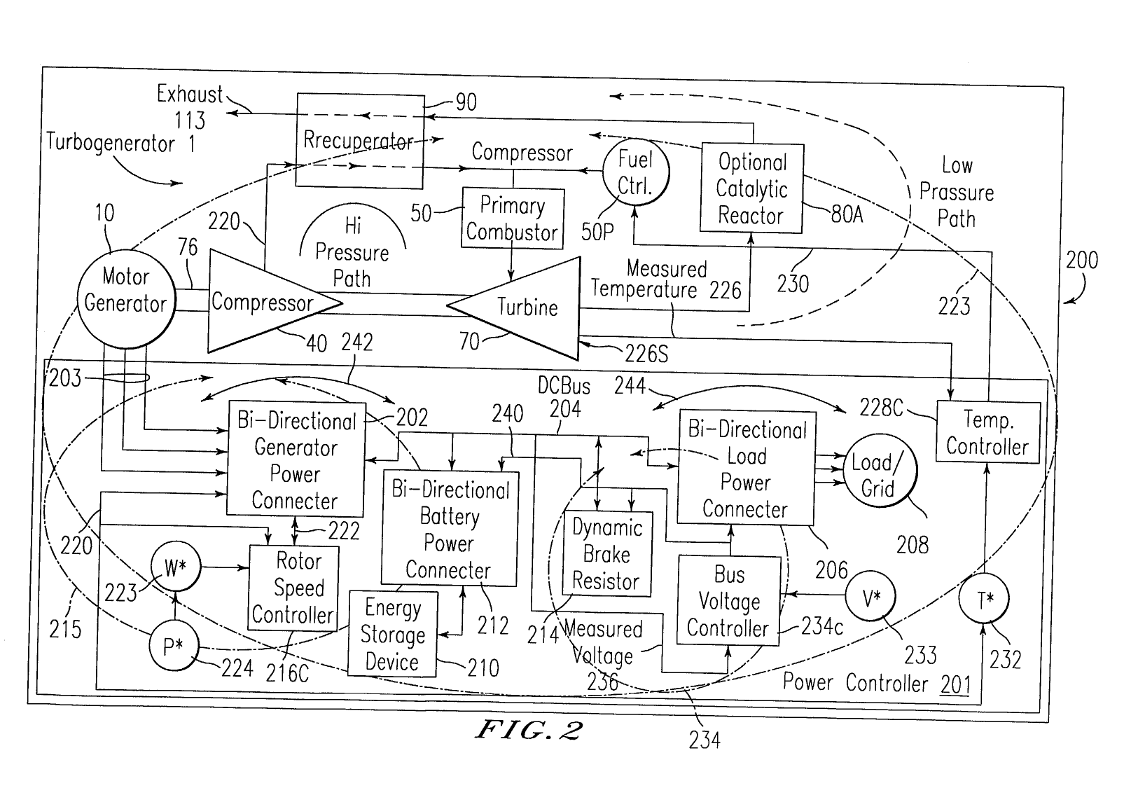

With reference to FIG. 1A, an integrated turbogenerator 1 according to the present disclosure generally includes motor/generator section 10 and compressor-turbine section 30. Compressor-turbine section 30 includes exterior can 32, compressor 40, combustor 50 and turbine 70. A recuperator 90 may be optionally included.

Referring now to FIG. 1B and FIG. 1C, in a currently preferred embodiment of the present disclosure, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 50A. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 74 is rotatably supported preferably by a bilateral thrust bearing 78A and 78B. Journal or radial bearing 75 and thrust bearings 78A and 78B may be fluid film or foil bearings.

Turbine wheel 72, bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 5 1D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 97 of recuperator 90, as indicated by gas flow arrows 108 and 109 respectively.

In an alternate embodiment of the present disclosure, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In still another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

An integrated turbogenerator is a turbogenerator in which the turbine, compressor, and generator are all constrained to rotate based upon rotation of the shaft to which the turbine is connected. The methods and apparatus disclosed herein are preferably but not necessarily used in connection with a turbogenerator, and preferably but not necessarily used in connection with an integrated turbogenerator.

Control System

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bidirectional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bidirectional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

Reference will now be directed to FIGS. 4-7, which illustrate a new and improved hydrodynamic compliant foil fluid film thrust bearing.

Referring to FIG. 4, rotating thrust disk 78 is shown in an exaggerated spaced relationship with respect to stationary thrust plate 78B. Top foil 314 and corrugated spring 316 are mounted between rotating thrust disk 78 and thrust plate 78B. Top foil 314 is positioned adjacent rotating thrust disk 78 and corrugated spring 316 is positioned adjacent thrust plate 78B. Corrugated spring 316 may be made from foil or other suitable material. Top foil 314 is secured to thrust plate 78B at top foil leading edge 315 by welding, brazing, or the like. Corrugated spring 316 is secured to thrust plate 78B at corrugated spring leading edge 317 by welding, brazing, or the like. Corrugated spring 316 may be made of foil and slotted along a part of the foil length. The slots or cuts run perpendicular to the corrugations and for a length less than the total foil length. Arrow 305 shows the direction of rotation of thrust disk 78. Shim 318 is placed between corrugated spring 316 and thrust plate 78B at the trailing edges 319 of top foil 314 and corrugated spring 316. Shim 318 may be located such that the trailing edge of the shim is aligned with the trailing edge of the top foil (as shown) or at any other position such that the vertical centerline of shim 318 is not more than one third of the top foil length from the trailing edge of the top foil. Shim 318 may be made of foil or other suitable material. Shim 318 may be secured to thrust plate 78B and/or corrugated spring 316 by welding, brazing, or the like. One or more shims 318 may be used in order to obtain the optimum results.

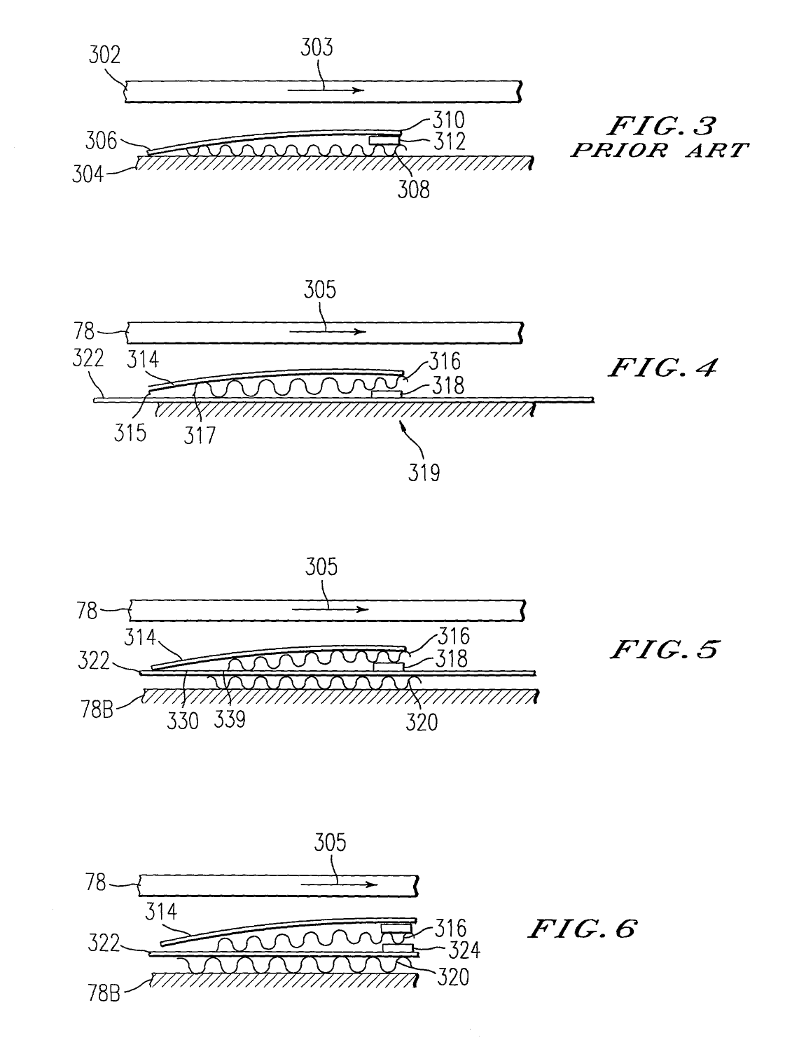

Referring to FIG. 5, optional corrugated spring 320 may be attached to thrust plate 78B by welding, brazing, or the like. Spring 320 may be corrugated as shown, or alternatively it may be a coiled spring, simply supported spring, or another spring design generally know by those familiar with the art. Optional spacer foil 322 may be attached in a like manner to corrugated spring 320. Top foil 314 and corrugated spring 316 would then be attached to spacer foil 322 by welding, brazing, or the like. Shim 318 could then be attached to either corrugated spring 316 or foil spacer 322. Corrugated spring 320 may be made from foil or the like.

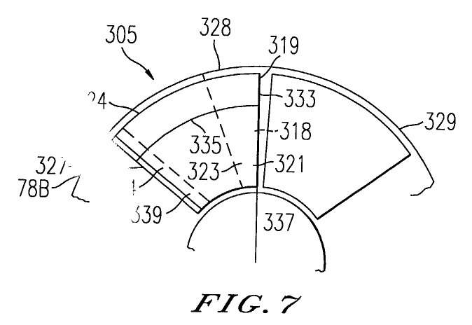

Referring to FIG. 6, shim 324 is shown placed between top foil 314 and corrugated spring 316 at outer radius 328 of top foil 314 and corrugated spring 316. Shim 324 may be secured to corrugated spring 316 by welding, brazing, or the like. In the preferred embodiment, shim 324 is used in combination with shim 318. The greatest reduction in thrust disk lift-off speed is achieved when the shims 318 and 324 are used in combination.

Referring to FIG. 7, only two fluid-dynamic wedge channels 327 and 329 are shown attached to thrust plate 78B. The number of channels 327, 329 used to encompass the surface of the thrust plate 78B is optional. Still referring to FIG. 7, shim 318 can more clearly be seen located at the trailing edges 319 of top foil 314 and corrugated spring 316 in the wedge channel 327. Also, shim 324 can more clearly be seen located at the outer radius 328 of top foil 314 and corrugated spring 316. Top foil 314 is shown attached to thrust plate 78B along weld line 330. Arrow 305 shows the direction of rotation of thrust disk 78.

Thus, one embodiment of this invention comprises of a plurality of equally spaced top foils 314 and corrugated springs 316 with one of more shims 318 underneath each corrugated spring situated at the trailing edges 319 of the respective top foils 314 and corrugated springs 316. Shim 318 trailing edge 321 is substantially aligned with trailing edges 319 of the respective top foil 314 and corrugated spring 316. Shim 318 leading edge 323 is substantially parallel with leading edge 330 of top foil 314 and leading edge 339 of corrugated spring 316 but is closer to the trailing edges 319 than the leading edges of either of those elements. The inner edges of top foil 314, corrugated spring 316, and shim 318 are substantially aligned and the outer edges of top foil 314, corrugated spring 316 and shim 318 are also substantially aligned. The surface area of shim 318 is about 5 to about 50 percent of 314.

Another embodiment of this invention comprises incorporating a shim 324 at the outer radius regions 328 of top foil 314 and corrugated spring 316 in addition to of the shim 318 situated at trailing edge 319 of each fluid wedge ramp. Shim 324 leading edge 331 is substantially aligned with the leading edge of top foil 314. Shim 324 trailing edge 333 is substantially aligned with trailing edges 319 of top foil 314 and corrugated spring 316. Shim 324 inner edge 335 is located closer to the outer edges 328 of the top foil 314 and corrugated spring 316 than to inner edges 337 of those elements. The surface area of shim 324 is about 5 to about 50 percent of the top foil 314.

Utilizing thin foil shims 318 alone or in combination with shims 324 is a low cost and sufficient method of creating aerodynamic fluid wedge ramp shapes. The shim or shims 318 underneath corrugated spring 316 allows top foil 314 to become more compliant with the corrugated foil spring 316. This added compliance has the advantages of (1) increasing load capacity, (2) increasing stability, and (3) reducing thrust disk lift off speed. All of these are desirable hydrodynamic compliant foil fluid film thrust bearing characteristics. The shim or shims 324 located at the outer radii increases bearing stiffness at the outer regions of the fluid-dynamic wedge channel where the highest pressure occurs. Improved stiffness at the outer radial regions of the fluid-dynamic wedge channel helps to maintain a uniform film thickness, which in turn (1) increases load capacity and (2) reduces lift off speed.

Although, in the above description, the compliant foil fluid film thrust bearing structure is referred to as being located between the thrust disk and the non-rotating thrust bearing surface 78B, those having ordinary skill in the art will understand that the compliant foil fluid film thrust bearing structure may be located between the thrust disk and either or both of the non-rotating thrust bearing surfaces 78A and 78B.

While specific embodiments of the invention have been illustrated and described, it is to be understood that these are provided by way of example only and that the invention is not to be construed as being limited thereto but only by the proper scope of the following claims.

What is claimed is:

1. A compliant foil fluid film thrust bearing comprising:
(a) a thrust disk rotatably supported by a non-rotating thrust bearing surface, said thrust disk having a direction of rotation; and
(b) a compliant bearing operably disposed between said thrust disk and said non-rotating thrust bearing surface, said compliant bearing including:
(i) a first corrugated spring, said first corrugated spring having a trailing edge with respect to the direction of rotation of said thrust disk;
(ii) a first shim between said first corrugated spring and said non-rotating thrust bearing surface, said first shim having a trailing edge substantially aligned with said first corrugated spring trailing edge; and
(iii) a top foil between said first corrugated spring and said thrust disk, said top foil having a trailing edge substantially aligned with said first corrugated spring trailing edge and said first shim trailing edge.

2. A compliant foil fluid film thrust bearing according to claim 1, wherein said first corrugated spring has a leading edge attached to said non-rotating thrust bearing surface.

3. A compliant foil fluid film thrust bearing according to claim 2, wherein said top foil has a leading edge attached to said non-rotating thrust bearing surface forward of said leading edge of said first corrugated spring leading edge.

4. A compliant foil fluid film thrust bearing according to claim 2, wherein said first shim is attached to said corrugated spring.

5. A compliant foil fluid film thrust bearing according to claim 2, wherein said first shim is attached to said non-rotating thrust bearing surface.

6. A compliant foil fluid film thrust bearing according to claim 1, wherein:
(a) said top foil includes:
(i) an outer edge;
(ii) an inner edge; and
(iii) a leading edge attached to said non-rotating thrust bearing surface;
(b) said first shim includes:
(i) an outer edge substantially aligned with said top foil outer edge;
(ii) an inner edge substantially aligned with said top foil inner edge; and
(iii) a leading edge extending substantially parallel with said top foil leading edge but located closer to said top foil trailing edge than to said top foil leading edge.

7. A compliant foil fluid film thrust bearing according to claim 6, wherein:
(a) said top foil leading edge, said top foil outer edge, said top foil inner edge, and said top foil trailing edge define a top foil surface area;
(b) said first shim leading edge, said first shim outer edge, said first shim inner edge, and said first shim trailing edge define a first shim surface area; and
(c) wherein said first shim surface area is equal to about 5 to about 50 percent of said top foil surface area.

8. A compliant foil fluid film thrust bearing according to claim 6, comprising:
a second shim between said top foil and said first corrugated spring, said second shim having (1) an outer edge substantially aligned with said first corrugated spring outer edge and (2) an inner edge extending substantially parallel to said first corrugated spring inner edge but located closer to said first corrugated spring outer edge than said first corrugated spring inner edge.

9. A compliant foil fluid film thrust bearing according to claim 8, wherein said top foil has an outer edge and second shim outer edge is substantially aligned with said top foil outer edge.

10. A compliant foil fluid film thrust bearing according to claim 9, wherein (1) said top foil includes a leading edge and said second shim includes a leading edge substantially aligned with said top foil leading edge and (2) said top foil includes a trailing edge and said second shim includes a trailing edge substantially aligned with said top foil trailing edge.

11. A compliant foil fluid foil film thrust bearing according to claim 10, wherein said top foil includes an inner edge and said second shim includes an inner edge substantially parallel to said top foil inner edge but located closer to said top foil outer edge than said top foil inner edge.

12. A compliant foil fluid film thrust bearing according to claim 11, wherein:
(a) said top foil leading edge, said top foil outer edge, said top foil trailing edge, and said top foil inner edge define a top foil surface area;
(b) said second shim leading edge, said second shim outer edge, said second shim trailing edge, and said second shim inner edge define a second shim surface area; and
(c) wherein said second shim surface area is equal to about 5 to about 50 percent of said top foil surface area.

13. A compliant foil fluid film thrust bearing according to claim 8, wherein said second shim is attached to said first corrugated spring.

14. A compliant foil fluid film thrust bearing according to claim 1, comprising:
(a) at least one spacer foil under said first corrugated spring; and
(b) a second corrugated spring between said at least one spacer foil and said non-rotating thrust bearing surface.

14. A compliant foil fluid film thrust bearing according to claim 14, wherein said first corrugated spring is attached to said at least one spacer foil, said at least one spacer foil is attached to said second corrugated spring, and said second corrugated spring is attached to said non-rotating thrust bearing surface.

16. A compliant foil fluid film thrust bearing according to claim 8, comprising:
(a) at least one spacer foil under said first corrugated spring; and
(b) a second corrugated spring between said at least one spacer foil and said non-rotating thrust bearing surface.

17. A compliant foil fluid film thrust bearing according to claim 16, wherein said first corrugated spring is attached to said at least one spacer foil, said at least one spacer foil is attached to said second corrugated spring, and said second corrugated spring is attached to said non-rotating thrust bearing surface.

18. A method of making a compliant foil fluid film thrust bearing comprising the steps of:
(a) providing a thrust disk rotatably supported by a non-rotating thrust bearing surface, said thrust disk having a direction of rotation; and
(b) providing a compliant bearing operably disposed between said thrust disk and said non-rotating thrust bearing surface, said compliant bearing including:
(i) a first corrugated spring, said first corrugated spring having a trailing edge with respect to the direction of rotation of said thrust disk;
(ii) a first shim between said first corrugated spring and said non-rotating thrust bearing surface, said first shim having a trailing edge substantially aligned with said first corrugated spring trailing edge; and
(iii) a top foil between said first corrugated spring and said thrust disk, said top foil having a trailing edge substantially aligned with said first corrugated spring trailing edge and said first shim trailing edge.

19. A method of making a compliant foil fluid film thrust bearing according to claim 18, comprising the step of attaching a leading edge of said first corrugated spring to said non-rotating thrust bearing surface.

20. A method of making a compliant foil fluid film thrust bearing according to claim 19, comprising the step of attaching a leading edge of said top foil to said non-rotating thrust bearing surface forward of said leading edge of said first corrugated spring leading edge.

21. A method of making a compliant foil fluid film thrust bearing according to claim 19, comprising the step of attaching said first shim to said corrugated spring.

22. A method of making a compliant foil fluid film thrust bearing according to claim 19, comprising the step of attaching said first shim to said non-rotating thrust bearing surface.

23. A compliant foil fluid film thrust bearing according to claim 18, comprising the steps of:
(a) forming said top foil with:
(i) an outer edge;
(ii) an inner edge; and
(iii) a leading edge and attaching said top foil leading edge to said non-rotating thrust bearing surface;
(b) forming said first shim with:
(i) an outer edge and substantially aligning said first shim outer edge with said top foil outer edge;
(ii) an inner edge and substantially aligning said first shim inner edge with said top foil inner edge; and
(iii) a leading edge extending substantially parallel with said top foil leading edge but located closer to said top foil trailing edge than to said top foil leading edge.

24. A method of making a compliant foil fluid film thrust bearing according to claim 23, comprising the steps of:
(a) defining a top foil surface area by said top foil leading edge, said top foil outer edge, said top foil inner edge, and said top foil trailing edge;
(b) defining a first shim surface area by said first shim leading edge, said first shim outer edge, said first shim inner edge, and said first shim trailing edge; and
(c) wherein said first shim surface area is equal to about 5 to about 50 percent of said top foil surface area.

25. A method of making a compliant foil fluid film thrust bearing according to claim 23, comprising the steps of:
(a) providing a second shim between said top foil and said first corrugated spring;
(b) forming said second shim with an outer edge, an inner edge, a leading edge, and a trailing edge;
(b) substantially aligning said second shim outer edge with said first corrugated spring outer edge;
(c) arranging said second shim inner edge substantially parallel to said first corrugated spring inner edge but located closer to said first corrugated spring outer edge than said first corrugated spring inner edge.

26. A method of making a compliant foil fluid film thrust bearing according to claim 25, comprising the steps of:
(a) forming said top foil with a outer edge; and
(b) substantially aligning said second shim outer edge with said top foil outer edge.

27. A method of making a compliant foil fluid film thrust bearing according to claim 26, comprising the steps of:
(a) forming said top foil with a leading edge and a trailing edge;
(b) forming said second shim with a leading edge and a trailing edge;
(c) substantially aligning said second shim leading edge with said top foil leading edge; and
(d) substantially aligning said second shim trailing edge said top foil trailing edge.

28. A method of making a compliant foil fluid foil film thrust bearing according to claim 27, comprising the steps of:
(a) forming said top foil with an inner edge;
(b) forming said second shim with an inner edge;
(c) arranging said second shim inner edge substantially parallel to said top foil an inner edge but located closer to said top foil outer edge than said top foil inner edge.

29. A method of making a compliant foil fluid film thrust bearing according to claim 28, comprising the steps of:
(a) defining a top foil surface area by said top foil leading edge, said top foil outer edge, said top foil trailing edge, and said top foil inner edge;
(b) defining a second shim surface area by said second shim leading edge, said second shim outer edge, said second shim trailing edge, and said second shim inner edge; and
(c) wherein said second shim surface area is equal to about 5 to about 50 percent of said top foil surface area.

30. A method of making a compliant foil fluid film thrust bearing according to claim 25, comprising the step of attaching said second shim to said first corrugate spring.

31. A method of making a compliant foil fluid film thrust bearing according to claim 18, comprising the steps of:
(a) providing at least one spacer foil under said first corrugated spring; and
(b) providing a second corrugated spring between said at least one spacer foil and said non-rotating thrust bearing surface.

32. A method of making a compliant foil fluid film thrust bearing according to claim 31, comprising the steps of:
(a) attaching said first corrugated spring to said at least one spacer foil;
(b) attaching said at least one spacer foil to said second corrugated spring; and
(c) attaching said second corrugated spring to said non-rotating thrust bearing surface.

33. A method of making a compliant foil fluid film thrust bearing according to claim 25, comprising the steps of:
(a) providing at least one spacer foil under said first corrugated spring; and
(b) providing a second corrugated spring between said at least one spacer foil and said non-rotating thrust bearing surface.

34. A method of making a compliant foil fluid film thrust bearing according to claim 33, comprising the steps of:
(a) attaching said first corrugated spring to said at least one spacer foil;
(b) attaching said at least one spacer foil to said second corrugated spring; and
(c) attaching said second corrugated spring to said non-rotating thrust bearing surface.

35. A compliant foil fluid film thrust bearing comprising:
(a) first means rotatably supported by non-rotating second means, said first means having a direction of rotation; and
(b) third means operably disposed between said first means and said non-rotating second means, said third means including:
(i) first spring means, said first spring means having a trailing edge with respect to the direction of rotation of said first means;
(ii) first shim means between said first spring means and said non-rotating second means, said first shim means having a trailing edge substantially aligned with said first spring means trailing edge; and
(iii) top foil means between said first spring means and said first means, said top foil means having a trailing edge substantially aligned with said first spring means trailing edge and said first shim means trailing edge.

36. A compliant foil fluid film thrust bearing according to claim 35, wherein:
(a) said first spring means includes:
(i) an outer edge;
(ii) an inner edge; and
(iii) a leading edge attached to said non-rotating second means;
(b) said first shim means includes:
(i) an outer edge substantially aligned with said first spring means outer edge;
(ii) an inner edge substantially aligned with said first spring means inner edge; and
(iii) a leading edge extending substantially parallel with said first spring means leading edge but located closer to said first spring means trailing edge than to said first spring means leading edge.

37. A compliant foil fluid film thrust bearing according to claim 36, comprising:
second shim means between said top foil means and said first spring means, said second shim means having (1) an outer edge substantially aligned with said first spring means outer edge and (2) an inner edge extending substantially parallel to said first spring means inner edge but located closer to said first spring means outer edge than said first spring means inner edge.

38. A compliant foil fluid film thrust bearing according to claim 35, comprising:
(a) at least one spacer means under said first spring means; and
(b) a second spring means between said at least one spacer means and said non-rotating second means.

39. A compliant foil fluid film thrust bearing according to claim 37, comprising:
(a) at least one spacer means under said first spring means; and
(b) a second spring means between said at least one spacer means and said non-rotating second means.

40. A method comprising the step of using a compliant foil fluid film thrust bearing made according to claim 18.

41. A method comprising the step of using a compliant foil fluid film thrust bearing made according to claim 25.

42. A method comprising the step of using a compliant foil fluid film thrust bearing made according to claim 31.

43. A method comprising the step of using a compliant foil fluid film thrust bearing made according to claim 33.
